(19) United States
(12) Patent Application Publication
(10) Pub. No.: US 2014/0260552 A1
(43) Pub. Date: Sep. 18, 2014

(54) HVAC UNIT TEST APPARATUS AND METHOD THEREFOR

(71) Applicant: Caterpillar Inc., Peoria, IL (US)

(72) Inventors: Gerald Richard Morris, Elmwood, IL (US); Arlene Jane Gottshall, Washington, IL (US); Mark Bradley Nitzsche, Edelstein, IL (US); Daniel Alan Spurgeon, Washington, IL (US)

(73) Assignee: Caterpillar Inc., Peoria, IL (US)

(21) Appl. No.: 14/291,673

(22) Filed: May 30, 2014

(51) Int. Cl. G01M 3/02

(52) U.S. Cl. CPC G01M 3/02
USPC 73/40

(57) ABSTRACT

A method to test a heating ventilation and air conditioning (HVAC) unit for external leaks is disclosed. The HVAC unit includes a first and a second port and is coupled to an auxiliary air movement test system using one of the first or the second ports. The other of the first or the second ports of the HVAC unit is blocked. The auxiliary air movement test system includes an air movement device, a conduit, a flow velocity sensor, and a pressure sensor. The air movement device enables airflow into the HVAC unit through the conduit. The flow velocity sensor positioned within the conduit measures air velocity. The pressure sensor is positioned in proximity to a condensate drain of the HVAC unit that measures the pressure within the HVAC unit. The method disclosed determines external leaks in the HVAC unit if the measured air velocity exceeds a predefined air velocity at a predetermined pressure.

### TECHNICAL FIELD

The present disclosure generally relates to Heating Ventilation and Air Conditioning (HVAC) units. More specifically, the present disclosure relates to a method to test HVAC units for leaks.

### BACKGROUND

Heating Ventilation and Cooling (HVAC) units frequently sustain conditions of leaks. Several methods are known in the art to detect leaks in HVAC units, out of which, some vary between a push-through system and a pull-through system. Additionally, some leak detection methods range from relatively simple solutions to those that apply sensitive electronics.

Relatively simple methods include options, such as, an application of a soap solution to a joint or a surface of the HVAC unit where a leak is suspected. Consequent bubble formations that arise from pressure differences between related HVAC regions mostly establish a leak presence. Another method proposes visual comprehension of leaks by use of options, such as, fluorescent dyes. Fluorescent dyes are invisible under ordinary lighting, but visible under ultraviolet (UV) light. In such cases, leaks are detected by visual inspection of the external surface of the HVAC unit. Other leak detection methods include the use of a compound that produces a distinct odor. Additionally, methods to detect leaks in the HVAC unit include acoustic leak detection systems, which use a compound that generates electric signals, corona discharge, and the like.

During a soap solution test, suspected leak areas may be relatively hard to reach, and therefore, preparing HVAC units for the related tests may be a rather tedious affair. Further, visual inspections of fluorescent dyes are observed to be vulnerable to incorrect assumptions, and may not allow for effective leak detection. When applying distinct odors to detect leaks, an odor may substantially emanate to an entire HVAC unit, thus imparting a general imperfection to this alternative as well. Acoustic leak detection systems generally include requirements of the tests to be carried out in closed and soundproof chambers. More particularly, acoustical tests also prescribe the need to have instruments that substantially decipher units of a sound signal, and thus, involve considerably expensive logistical pre-requisites.

One additional limitation of these noted methods also include the requirement to disassemble all or at least a part of the HVAC units to accurately detect leaks. Having the ability to disassemble the HVAC system when such leak tests need to be performed on mobile machines and equipment is typically not desirable. Accordingly, many of the above noted test methodologies are not usable on HVAC systems that are isolated, confined, and packaged in hard to access places, such as those found on mobile machines and equipment. Moreover, current HVAC leak testing methods are mostly complex, expensive, time consuming, and may not be effective in detecting each leak occurrence.

### SUMMARY OF THE DISCLOSURE

In the current disclosure, a method to test a heating ventilation and air conditioning (HVAC) unit for external leaks is disclosed. The HVAC unit includes a first port that defines one of an inlet or an outlet of the HVAC unit. The HVAC unit also includes a second port that defines the other of the inlet or an outlet of the HVAC unit. The first port and the second port are in fluid communication with each other. The HVAC unit further includes a heat exchanger and a condensate drain. The method includes coupling an auxiliary air movement test system to the HVAC unit, where the air movement test system includes an air movement device, a conduit, a flow velocity sensor, and a pressure sensor. The conduit extends from the air movement device to one of the first or second ports of the HVAC unit, and positions the flow velocity sensor within. More particularly, the pressure sensor is positioned close to the condensate drain. The method then includes blocking the other of the first or second ports of the HVAC unit to facilitate airflow through the first port or the second port that the conduit is coupled to. The pressure sensor then measures the air pressure within the HVAC. An adjustment to the output of the air movement device stabilizes the air pressure within the HVAC unit at a predetermined pressure. Once the air pressure within the HVAC unit is stabilized, the flow velocity sensor measures the air velocity within the conduit. Based on the measured air velocity, an amount of external leakage from the HVAC unit is determined. If the measured air velocity exceeds a predefined air velocity at the predetermined pressure, the method includes a reduction to the external leakage of the HVAC unit.

Other features and advantages of the disclosure will become apparent to those skilled in the art, upon review of the following detailed description and drawings.

### BRIEF DESCRIPTION OF DRAWINGS

FIG. 1 illustrates a sectional side view of an exemplary heating ventilation and air conditioning (HVAC) unit, in accordance with the concepts of the present disclosure;

FIG. 2 illustrates a block diagram of an auxiliary air movement test system with a push-through unit and shown fitted with the HVAC unit of FIG. 1, in accordance with the concepts of the present disclosure;

FIG. 3 illustrates a block diagram of the auxiliary air movement test system with a pull-through unit and shown fitted with the HVAC unit of FIG. 1, in accordance with the concepts of the present disclosure;

FIG. 4 illustrates a block diagram of a second embodiment auxiliary air movement test system with a push-through unit and shown fitted within the HVAC unit of FIG. 1, in accordance with the concepts of the present disclosure;

FIG. 5 illustrates a block diagram of a second embodiment auxiliary air movement test system with a pull-through unit and shown fitted within the HVAC unit of FIG. 1, in accordance with the concepts of the present disclosure; and

FIG. 6 illustrates a flow chart explaining a method to test the HVAC unit of FIG. 1, for external leaks, in accordance with the concepts of the present disclosure.

### DETAILED DESCRIPTION

Wherever possible, the same reference numbers will be used throughout the drawings and specification to refer to the same or the like parts. Referring to FIG. 1, shown is a sectional side view of an exemplary Heating Ventilation and Air Conditioning (HVAC) unit 100. The HVAC unit 100 includes a first port 102 defining an inlet, a second port 104 defining an outlet of the HVAC unit 100, a unit blower 106, a heat exchanger 108, and a condensate drain 110. The unit blower 106, heat exchanger 108 and condensate drain 110 form HVAC components 115. The heat exchanger 108 includes a heating coil 112 and a cooling coil 114 that manage temperature of airflow exiting the HVAC unit 100.

The first port 102 and the second port 104 of the HVAC unit 100 are in fluid communication through a flow passage 116, which provides airflow through the HVAC unit 100. Generally, the HVAC unit 100, in a push-through orientation, includes HVAC components 115 packaged to occupy a space between the first port 102 and the second port 104. The unit blower 106 may be placed to draw air from an ambient 105 at the first port 102 and to drive airflow toward the heat exchanger 108 so that air is pushed through flow passage 116, over the heat exchanger 108, and out the second port 104 to a conditioned air output 107 (e.g., an operator cab).

Alternatively, the HVAC unit 100′ may be defined as a pull-through orientation, as shown, e.g., in FIG. 3, and includes the first port 102′ and the second port 104′ in fluid communication with each other through flow passage 116. Generally, the HVAC unit 100′, in this pull-through orientation, includes HVAC components 115 packaged to occupy a space between the first port 102′ and the second port 104′. The unit blower 106′ may be placed to draw air from the ambient 105′ at the first port 102′, and, further, to pull airflow over the heat exchanger 108 so that air is pulled through flow passage 116, over the heat exchanger 108, and out the second port 104′ to a conditioned air output 107′ (e.g., an operator cab).

Certain aspects of the push-through HVAC unit 100 are similar to the pull-through HVAC unit 100′. Therefore, one description for the HVAC unit 100 will be provided. However, differences relative to HVAC unit 100′ will also be provided, if any. The unit blower 106 is positioned within the HVAC unit 100, between the first port 102 and the second port 104. The unit blower 106 may be any of the conventionally available blowers known to those with ordinary skill in the art. The unit blower 106 may be an electrically driven fan, hydraulically driven fan, or powered by any other means known to those with ordinary skill. The unit blower 106 creates airflow within flow passage 116 of the HVAC unit 100 by pulling in the air from an ambient or source of air from the surrounding atmosphere. Thereafter, the unit blower 106 generates the airflow within the HVAC unit 100, and then pushes the airflow (in a pusher system within the HVAC unit 100) over the heat exchanger 108 or alternatively pulls the airflow (in a puller system within the HVAC unit 100′) over the heat exchanger 108.

The condensate drain 110 may be positioned below the cooling coil 114 of the heat exchanger 108. The condensate drain 110 assists in draining the water deposited over the cooling coil 114 by condensation or otherwise. Moreover, water deposits may be present in the airflow as well and additional means for removing such airborne water are contemplated, such as airborne fluid removal through a condenser unit (not shown).

The push-through unit refers to the type of HVAC unit 100 with the unit blower 106, positioned in proximity to the first port 102 that defines the inlet of the HVAC unit 100. The unit blower 106 is positioned to propel air towards the heat exchanger 108 of the HVAC unit 100. The unit blower 106 draws air from the ambient 105 through the first port 102 (inlet) and then pushes the air through to pass over the heat exchanger 108 for heating/cooling of the air and provide the same to the second port 104 (outlet) as conditioned air output 107.

The pull-through unit refers to the type of HVAC unit 100′ with the heat exchanger 108, positioned in proximity to the first port 102′ that defines the inlet of the HVAC unit 100′. The heat exchanger 108 is positioned in-between the first port 102′ and the unit blower 106′. Air from the ambient 105′ is drawn into the first port 102′ and thereafter passes over the heat exchanger 108, to heat/cool the air and then is further drawn toward the unit blower 106′ and is finally provided to the port 104′ (outlet) as conditioned air output 107′.

The push-through and the pull-through schemes disclosed above form basis for testing HVAC units according to the present disclosure. Those testing methodologies are presented in the disclosure below.

Referring to FIG. 2, a block diagram of an auxiliary air movement external leak test system 200 is shown in application with the HVAC unit 100. The auxiliary air movement external leak test system 200 has a push-through configuration for conducting an external leak test. The auxiliary air movement external leak test system 200 includes an air movement device 202, a conduit 204, a flow velocity sensor 206, a pressure sensor 208, and a blocking means 210. Under this configuration, the HVAC unit 100 sustains a positive pressure between the air movement device 202 and the heating and cooling coils 112 and 114 (shown in FIG. 1).

The air movement device 202 is externally arranged and is configured to generate and push airflow into the HVAC unit 100 from the side of the unit blower 106 (shown in FIG. 1). More particularly, airflow may enter the HVAC unit 100 through the first port 102, which, for ease of reference, may be interchangeably referred to as an inlet 102, hereinafter. The air movement device 202 may be a blower, a pump, a fan, and/or the like, and may be powered electrically, hydraulically, or by other conventional means. The air movement device 202 may be selected and sized to create a positive pressure reading on pressure sensor 208 while under full load—meaning the air movement device 202 will experience almost complete obstruction since the second port 104 is blocked.

The conduit 204 allows passage and direction of the generated airflow into the HVAC unit 100. Structurally, the conduit 204 extends from the air movement device 202, on the unit blower (106) side, and communicates to the HVAC unit 100 at the inlet 102. At the inlet 102, the conduit delivers the airflow. Towards the side of the air movement device 202, the conduit 204 is shaped to complement and fasten over fixtures (not shown) provided over the air movement device 202. Towards the HVAC unit (100) side, the conduit 204 similarly extends to connect and communicate with the HVAC unit's inlet 102. Connections at those respective conduit ends may include bolting, snap fitting, and other conventional fastening means. Also, those connections may be releasably secured. The conduit 204 may be manufactured from a waterproof and substantially flexible material to enable ease of assembly and operation. Further, high-grade plastics may be contemplated for the conduit's construction.

The flow velocity sensor 206, which may be one of the commonly known air velocity sensors in the art, is positioned and retrofitted within the conduit 204 to measure an airflow velocity flowing there through. Examples of the flow velocity sensor 206 may include, but is not limited to, an anemometer, electrical sensors, and/or an impulse sensor. Further, the flow velocity sensor 206 is configured to sense airflow velocity and generate a corresponding velocity signal. Those signals may be provided to an operator via analog and/or digital means, which may include a visual display, an audible message, or a combination of both.

The pressure sensor 208 may be one of the commonly known pressure sensing devices in the art, such as a monometer, and may be configured to monitor a pressure difference created by an airflow directed into (or out) of the HVAC unit 100. More specifically, the pressure sensor 208 is positioned proximately to the condensate drain 110 of the HVAC unit 100, to measure the pressure difference within the HVAC unit 100 and an outside environment. Similar to the flow velocity sensor 206, the pressure sensor 208 too senses pressure within the HVAC unit 100, generates a corresponding signal, and provides that signal through analog or digital means. Visual, audible, or a combination of both, may constitute a feedback to an operator. It is evident to the person with ordinary skills in the art that the pressure sensor 208 type is not limited to a manometer alone, but may incorporate other known technologies in the art.

The blocking means 210 may be sealably positioned at the second port 104, which, for ease of reference, is interchangeably referred to as an outlet 104, hereinafter. The blocking means 210 blocks an incoming airflow within the HVAC unit 100 and avoids an airflow escape from the outlet 104. The blocking means 210 may include an impermeable, flexible sheet, lightweight in construction, and may have portions that are securable to related portions of the HVAC unit 100 at the outlet 104. Those securable portions may include provisions for bolting, riveting, applying temporary industrial adhesives, and the like. By having the blocking means 210 positioned in that manner, the disclosed layout allows a pressure to rise and eventually stabilize within the HVAC unit 100. Additionally, the blocking means 210 may be generally hydrophobic to repel any fluid accumulation generated within the HVAC unit 100. Moreover, chemically stable and heat resistive materials may be sought and known techniques may be applied to manufacture the blocking means 210.

Referring to FIG. 3, a similar block diagram of an auxiliary air movement external leak test system 200′ is shown, where, the leak test is in application with the HVAC unit 100′. More specifically, the auxiliary air movement external leak test system 200′ has a pull-through configuration for conducting an external leak test. The auxiliary air movement external leak test system 200′ includes an air movement device 202′, a conduit 204′, a flow velocity sensor 206′, a pressure sensor 208′, and a blocking means 210′. Evidently, each of these components is similar in form and function to those described in conjunction with FIG. 2. Under this configuration, the HVAC unit 100′ sustains a negative pressure between the air movement device 202′ and heating and cooling coils 112 and 114 (shown in FIG. 1).

The air movement device 202′ is externally arranged with the HVAC unit 100 likewise to the FIG. 2 embodiment. An air inlet 102′ is defined on the blower (106) side of the HVAC unit 100′ and an outlet 104′ is defined oppositely, at the heating and cooling coil (112 and 114) side. However, the air movement device 202′ is configured to pull airflow from the HVAC unit 100 to generate negative pressure within, instead of pushing air inside and generating a positive pressure. Accordingly, an arrangement and operation of this embodiment relatively differs from the one described above.

In further detail, the component set including the air movement device 202′, the conduit 204′, and the flow velocity sensor 206′, is arranged on the side of the heating and cooling coils 112 and 114 (shown in FIG. 1). That arrangement differs from the previous embodiment where the component set is laid out on the side of the unit blower 106′.

The conduit 204 extends from the HVAC unit 100 at the outlet 104′ and communicates to the air movement device 202. Those extensions and conduit ends defined towards the air movement device 202′ and the HVAC unit (100) assume a similar configuration as has been already described in conjunction with FIG. 2. The conduit 204′ allows evacuation and direction of the generated airflow out the HVAC unit 100, instead of an air push.

The blocking means 210′ blocks the inlet 102′ of the HVAC unit 100′, instead of blocking the outlet 104. That arrangement restricts airflow into and out of the HVAC unit 100 via the inlet 102′. The blocking means 210′ too may be understood to include similar features as has been already described in conjunction with FIG. 2.

Similarities to the FIG. 2 embodiment however include the pressure sensor's (208′) arrangement. More particularly, the pressure sensor 208′ is positioned proximate to a condensate drain 110′ of the HVAC unit 100′ to measure pressure differences within the HVAC unit 100, during the test. Additionally, a series of layout for the component set (the air movement device 202′, the conduit 204′, and the flow velocity sensor 206′) may remain similar as well. Accordingly, the flow velocity sensor 206′ is positioned within the conduit 204′ to measure velocity of an airflow flowing there through, as in the FIG. 2 embodiment. Also, airflow is generated by the air movement device 202′.

Once external leak tests are over, in general, internal leak tests (described in FIG. 4 and FIG. 5) are initiated. Those of ordinary skill in the art may prescribe plugging of holes, vents, and apertures, within the HVAC unit 100 before initiating internal leak tests, as described in the forthcoming disclosure.

Referring to FIG. 4, a block diagram of an exemplary internal leak test system 400 is shown that determines internal leaks in the HVAC unit 100. The internal leak test system 400 applies a push-through leak testing scheme for checking leaks within the HVAC unit 100. To conduct an internal leak tests, the HVAC unit 100 may not be subject to external equipment connections, such as the conduit 204 and the air movement device 202. Preferred embodiments of the present disclosure prescribe internal leak tests that function with the application of the flow velocity sensor 206 and the pressure sensor 208 alone.

Accordingly, an exemplary push-through internal leak test layout of FIG. 4 proposes a placement of the flow velocity sensor 206 at the outlet 104, while having the unit blower 106 positioned at the inlet 102. Placement of the flow velocity sensor 206 may involve diverting an outgoing airflow substantially entirely to pass across the flow velocity sensor 206. In that manner, velocity of air moving out of the HVAC unit 100 may be accurately gauged. Measures to incorporate those airflow diverting features may include employing various conduit types that occupy minimal external space. Some techniques may include customizations to general conduit and duct designs to suit minimal space considerations.

In the push-through internal leak test, an outward side 408 (facing the outlet 104) of the heating coil 112 is blocked from an air passage. That blockage is accomplished by positioning a blocking means 410 at the outward side 408. The blocking means' (410) overall structure may remain similar to the blocking means 210 and 210′ (shown in FIG. 2 and FIG. 3). In some embodiments, the blocking means 410 may be a seal-board and may include measures to fasten over the outward side 408 of the heating coil 112. Fastening measures may include bolting, using screwed connections, applying temporary adhesive formulations along the blocking means' periphery, and the like. Further, the pressure sensor 208 is positioned proximately to the condensate drain 110 of the HVAC unit 100, as held in the previous embodiments.

As air is drawn into the HVAC unit 100, an air reception portion 420 is defined between the inlet 102 and the blocking means 410. Beyond the blocking means 410, a region between the blocking means 410 and the outlet 104, where negligible air is supposedly transferred, defines a blocked portion 422.

Referring to FIG. 5, a block diagram of an internal leak test system 400′ for the HVAC unit 100′ is shown. The internal leak test system 400′ applies a pull-through leak testing scheme for checking leaks within the HVAC unit 100′. Several aspects of this test remain similar to the push-through internal leak test described in FIG. 4. Relatively minor differences, however, exist in component arrangement. Those discussions are found below.

Unlike the push through leak test discussed in conjunction with FIG. 4, the embodiment here prescribes a reversal of the inlet and outlet in the HVAC unit 100′. The inlet 102′, oppositely configured on the side of the heating and cooling coils 112 and 114, is subject to an airflow entry, while the outlet 104′, oppositely configured on the side of the unit blower 106′, sustains airflow exit. The flow velocity sensor 206′ is arranged at the outlet 104′, substantially abutting the unit blower 106′ (positioned within the HVAC unit 100′). Further, the blocking means 410′ is attached to a corresponding outward side 408′ (facing the outlet 104′) of the cooling coil 114′. Features for attaining that attachment remain similar to what has been described in connection with FIG. 4. Also, the flow velocity sensor 206′ is attached to the outlet 104′ in a manner as already described. Additionally, the pressure sensor 208′ is disposed in between the outlet 104′ and the blocked cooling coil 114′ of the HVAC unit 100′.

As air is drawn out of the HVAC unit 100 during tests, an air evacuation portion 424 is defined extending from the blocking means 410 to the outlet 104′. A region between the inlet 102′ and the blocking means 410, from where negligible air is collected, defines a blocked portion 426.

Referring to FIG. 6, a flow chart 600 of an exemplary method to test the HVAC unit 100 for external leaks is shown. It will be understood that both the push-through configuration (FIG. 2) and the pull-through configuration (FIG. 3) will be explained with regard to FIG. 6; therefore primed numerals define the latter. This exemplary method is discussed in conjunction with FIG. 1, FIG. 2, and FIG. 3.

The method to test the HVAC unit 100 for external leaks initiates at step 602. At step 602, the auxiliary air movement external leak test system 200 is coupled to the HVAC unit 100. The method proceeds to step 604.

At step 604, the blocking means 210, 210′ is positioned to block the inlet (102, 102′) or outlet (104, 104′), depending upon whether it is desired to conduct one of a push-through or a pull-through leak test. The method proceeds to step 606.

At step 606, the unit blower 106, 106′ enables airflow through the inlet 102, 102′ and directs airflow through the outlet 104, 104′. Airflow is transferred through conduit 204, 204′. The method proceeds to step 608.

At step 608, pressure sensor 208, 208′ measures the air pressure within the HVAC unit 100, 100′. The method proceeds to step 610.

At step 610, a continuous flow of air through the HVAC unit 100, 100′ is established and pressure is thereafter stabilized. The pressure signal from the pressure sensor 208, 208′ is monitored and the output of the air movement device 202 is adjusted until such pressure reading is stabilized at a predetermined pressure value. The method proceeds to step 612.

At step 612, the flow velocity sensor 206, 206′ measures the air velocity within the conduit 204, 204′. The method proceeds to step 614.

At step 614, the method includes determining an amount of external leakage from the HVAC unit 100, 100′ based on the measured air velocity. The method proceeds to step 616.

At step 616, the measured air velocity is compared with a predefined value, and if it exceeds this predefined air velocity then it is determined that an external leak exists. The external leak of the HVAC unit 100 is then resolved by appropriate means understood by those having ordinary skill in the art. The method ends at step 616.

### INDUSTRIAL APPLICABILITY

During operation, the HVAC unit 100, 100′ (prime denotes pull-through unit) is adapted to provide conditioned air into a closed atmosphere, such as an operation chamber, a cab of a machine, and the like.

During exemplary external leak testing procedures, the push-through and pull-through mechanisms, as disclosed in FIG. 2 and FIG. 3, will now be discussed. First, the conduit 204, the flow velocity sensor 206, and the air movement device 202, are coupled to the HVAC unit 100, 100′. The applicable auxiliary air movement external leak test system 200, 200′ of FIG. 2 and FIG. 3 may then be carried out.

When initiating an external leak test by having a push-through orientation, an operator activates the air movement device 202, which generates airflow. The generated airflow pushes into the HVAC unit 100 via the conduit 204 and enters into the HVAC unit 100 via the inlet 102. As the airflow proceeds, the flow velocity sensor 206, positioned within the conduit 204, measures a velocity of the passing air. The blocking means 210 blocks the outlet 104, thereby causing the inflowing airflow to create a positive pressure within the HVAC unit 100. The pressure sensor 208 measures that positive pressure throughout the test duration. An output of the air movement device 202 is adjusted until a permissible upper limit pressure within the HVAC unit 100 is stabilized at an upper threshold value. Once the pressure within the HVAC unit 100 is stabilized, the flow velocity sensor 206 monitors the velocity of the airflow within the conduit 204. If the velocity of the airflow exceeds a predefined velocity, the HVAC unit 100 has an external leak. The HVAC unit 100 is then inspected to find and repair the leak.

The HVAC unit 100′ is tested for external leaks also by using air movement external leak testing system 200′, which prescribes an airflow pull-through, as depicted in FIG. 3. An operator activates the air movement device 202′, generating a counter airflow that flows out of the HVAC unit 100′ and as the generated airflow pulls air from the HVAC unit 100′, air housed within is purged via the outlet 104′. This purged air travels through the conduit 204′ and escapes through the unit blower 106′. As airflow exit occurs, the flow velocity sensor 206′, positioned within the conduit 204, measures a velocity of the passing air. Blocking the inlet 102′ by the blocking means 210′ causes the out flowing airflow to create a negative pressure within the HVAC unit 100′. The pressure sensor 208′ measures that negative pressure throughout the test duration. An output of the air movement device 202 is adjusted to a permissible upper limit and the negative pressure within the HVAC unit 100 is stabilized and adjusted to a lower threshold value. An output of the air movement device 202 may be controlled by adjusting the speed of the air movement device 202. Once stabilized, the flow velocity sensor 206 monitors the velocity of the airflow within the conduit 204. An air velocity, which exceeds a predefined limit, signals the possible presence of an external leak. Accordingly, the leak in the HVAC 100′ is identified and repaired.

An exemplary embodiment for an external leak test may set a predetermined pressure of 1″ Hg (manometer reading for example) within the HVAC unit 100, 100′, when restricting the velocity of the airflow through the conduits 204 and 204′ at a predefined limit of 755 ft/min, for example.

Once the external leak test is performed on the HVAC unit 100, 100′ an internal leak test may be carried out on the HVAC unit 100, 100′. This ensures that the HVAC unit 100, 100′ performs at optimum efficiency with negligible or no leaks.

The internal leak test of a push-through HVAC unit 100 (FIG. 4) will now be described. During an exemplary test operation, an operator activates the air movement device 202. Air flows into the HVAC unit 100 through the inlet 102 generated by unit blower 106. Thereafter, the airflow pushes towards heat exchanger 108. By having the heating coil 112 blocked at the outward side 408 by the blocking means 410, inflowing air creates a positive pressure, and, more particularly, a pressure drop through the heat exchanger 108 is measured using the pressure sensor 208. Next, the output of the unit blower 106 is adjusted and the pressure sensor 208 is monitored. The pressure within the air reception portion 420 of the HVAC unit 100 is stabilized and adjusted to a predefined value. Presence of leaks within the air reception portion 420 will be indicated by a predefined loss of pressurized air within the blocked portion 422. The loss of air is detected by flow velocity sensor 206 as it exits the HVAC unit 100. If the velocity of escaping air is measured and exceeds a predetermined threshold, then it may be deduced that there is an internal leak. Measures may be taken to minimize or repair such leaks.

The internal leak test of HVAC unit 100′ (FIG. 5) will now be described. Regarding the pull-through internal leak testing, an operator activates the unit blower 106′ to generate airflow. As the outward side 408′ of the cooling coil is blocked, a negligible amount or no air should be flowing through the blocked portion of the HVAC unit 100′. The airflow generated by the unit blower 106′ draws air through the HVAC 100′ and directs the same towards the outlet 104′. Since the heating coil 112 of the pull-through HVAC unit 100′ is blocked, out-flowing air generates a vacuum or negative pressure, and more particularly, the pressure drop across heat exchanger 108′ is measured using pressure sensor 208′. Once the pressure signal from pressure sensor 208′ reaches a predetermined value, the output of the unit blower 106′ is stabilized, and, subsequently, the flow velocity sensor 206, positioned at the outlet 104′, is configured to measure the velocity of the airflow exiting from the outlet 104′. If the velocity measurement exceeds a predefined value, the presence of an internal leak is likely. The internal leak is then identified and repaired.

An exemplary embodiment for an internal leak test prescribes maintenance of a predetermined pressure of 1″ Hg (manometer reading for example) within the HVAC unit 100, 100′, and, more particularly, within the air reception portion 420 (and the air evacuation portion 424), when restricting the velocity of the airflow at a predefined limit of 302 ft/min.

Post HVAC installation, service, and maintenance it would be highly desirable to affirmatively confirm that all wetted components, ducts, passages and joints therebetween were free from leaks to ensure the highest efficiency output of the final HVAC system. However, since most HVAC systems may not be tested in situ, the present disclosure sets forth external and internal leaks testing of the HVAC system. The air movement external leak test system 200, 200′ and internal leak test system 400, 400′ may be employed as a portable kit to enable operators and HVAC inspectors with the versatility and flexibility to apply the concepts of the present disclosure in a variety of HVAC applications.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. A method to test a heating ventilation and air conditioning (HVAC) unit for external leaks, the HVAC unit including a first port defining one of an inlet or an outlet of the HVAC unit and a second port defining the other of the inlet or the outlet of the HVAC unit, wherein the first port and the second port are in fluid communication, the HVAC unit also include a heat exchanger and a condensate drain, the method comprising:
coupling an auxiliary air movement test system to the HVAC, the auxiliary air movement test system including an air movement device, a conduit extending from the air movement device, a flow velocity sensor positioned within the conduit, and a pressure sensor; wherein the conduit is coupled to one of the first or second ports of the HVAC unit and the pressure sensor is disposed proximate the condensate drain;
blocking the other of the first or second ports of the HVAC unit;
enabling airflow through the first port or the second port that the conduit is coupled to;
measuring air pressure within the HVAC unit with the pressure sensor;
stabilizing air pressure within the HVAC unit at a predetermined pressure by adjusting an output of the air movement device;
measuring air velocity within the conduit with the flow velocity sensor;
determining an amount of external leakage from the HVAC unit based on the measured air velocity; and
if the measured air velocity exceeds a predefined air velocity at the predetermined pressure, reducing the external leaks of the HVAC unit.
